(19) United States
(12) Patent Application Publication
(10) Pub. No.: US 2009/0208621 A1
(43) Pub. Date: Aug. 20, 2009

(54) Cooking Appliance

(75) Inventor: Simon Dotan, Netanya (IL)

Correspondence Address: MARSTELLER & ASSOCIATES, P O BOX 803302, DALLAS, TX, 75380-3302, US

(73) Assignee: EVERLASTING GLORY LIMITED, Wanchai (HK)

(21) Appl. No.: 10/596,443

(22) PCT Filed: Dec. 13, 2004
(86) PCT No.: PCT/IL04/01125

§ 371 Date: Dec. 20, 2006

(30) Foreign Application Priority Data
Dec. 15, 2003 (IL) 159382

(51) Int. Cl. A23L 1/01; A47J 43/00; F27D 11/00; A47J 37/12

(52) U.S. Cl. 426/389; 99/348; 219/441

(57) ABSTRACT

Appliance for cooking food articles, which comprises a container for receiving an amount of the food articles to be cooked and an amount of cooking liquid sufficient to only partially immerse the food articles therein. The container has a discharge and comprising an opening for discharging the cooked food articles and a cover for closing the opening during the cooking operation. The appliance also comprises a helical paddle; a shaft on which the paddle is mounted, such that shaft is rotatably supported by the container; a motor for driving the shaft; means for causing the motor to drive the shaft in either the cooking direction or the discharging direction; and a support for supporting the container in a slightly slanted position wherein the front end of the shaft is slightly higher than the rear end thereof.

### FIELD OF THE INVENTION

This invention relates to a cooking appliance and method particularly, but not exclusively, useful for frying food. The appliance and the method of the invention are also useful in other applications, including steaming food, cooking rice, and popping corn.

### BACKGROUND OF THE INVENTION

Many types of frying appliances have been developed and are described in the literature, for example in U.S. Pat. Nos. 4,873,920, 4,901,633, 5,010,805, 5,146,841, 5,165,329, 5,379,684, 5,524,527, 5,543,166, 5,584,234, and 5,611,265. In most of these appliances, the food articles are completely immersed in hot oil during the frying process thereby causing them to become soaked in oil. This detracts from the taste and is also generally considered unhealthy. Moreover, such appliances require large quantities of frying oil, long frying times, and large quantities of energy for heating the frying oil.

U.S. Pat. No. 5,543,166 discloses a cooking appliance which includes a drum for receiving the food articles to be cooked, said drum having small openings and being mounted about a horizontal axes such that only its lower part is immersed into the hot cooking liquid. By the rotation of the drum, the food articles tumble into and out of the cooking liquid.

U.S. Pat. No. 6,077,555 discloses an appliance for cooking food articles, including: a receptacle for receiving said food articles and a sufficient quantity of cooking liquid to only partially immerse said food articles therein; a heater for heating the cooking liquids; a paddle movably mounted in the said receptacle; and a periodically reversing drive for driving the paddle back and forth in the receptacle to move the food particles back and forth through the cooking liquid. To remove the cooked food articles from the cooking, appliance, a screen basket is provided, which may be removed from the receptacle while leaving the excess liquid within the same.

U.S. Pat. No. 6,453,801 B1 discloses a cooking appliance which includes a liquid container for receiving the cooking liquid, a heater for heating the same, a perforated rotary drum for receiving the food articles to be cooked, and a drive for rotating said drum. The liquid container is movable selectively to a raised position, wherein the cooking liquid contacts the food articles in the drum or to a lower position wherein the cooking liquid is below the food articles in the drum. Said lower position may be used for steam heating or preheating food articles.

Thus, some prior art devices and methods have attempted to avoid completely immersing the food articles immersed in hot cooking liquid during the frying process, however they propose, for this purpose, somewhat complicated devices that are expensive to make and inconvenient to use, that do not provide easy loading and discharge of food products, and that implement rather awkward cooking processes.

It is therefore a purpose of this invention to overcome all the aforesaid drawbacks of prior art devices and methods.

It is an additional purpose to provide a cooking appliance overcoming said drawbacks while having a simple structure.

It is a further purpose to provide such a cooking appliance that is inexpensive to make and to maintain.

It is a still further purpose to provide such a cooking appliance that permits a simple cooking process.

It is a still further purpose to provide such a cooking appliance that permits easy discharge of the cooked food products.

It is a still further purpose to provide such a cooking appliance that is excellent for frying, but can be used for other purposes, such as steaming food products and popping corn.

It is a still further purpose to provide a simple and effective cooking method.

It is a still further purpose to provide a cooking method that is automatic and does not require interventions from beginning to end.

It is a still further purpose to provide a simple device for cooking, frying, steaming, having an automatic arrangement for automatically collecting the cooking liquid when the cooking process is done, eliminating the need for pouring and handling very hot liquids.

It is a still further purpose to provide a simple device for cooking, frying, steaming, having an automatic arrangement for self-cleaning after the cooking process is done, by simply adding water with detergent and letting the device run for some time.

Other purposes and advantages of this invention will appear as the description proceeds.

### SUMMARY OF THE INVENTION

The invention provides an appliance for cooking food articles which comprises:
a) a container, for receiving an amount of the food articles to be cooked and an amount of cooking liquid sufficient to only partially immerse the food articles therein, said container having a discharge end comprising an opening for discharging the cooked food articles and cover means for closing said opening during the cooking operation;
b) a helical paddle;
c) a shaft on which said paddle is mounted, which shaft is rotatably supported by said container;
d) a motor for driving said shaft;
e) means for causing said motor to drive said shaft in either one of two directions, one of them been called hereinafter “the cooking direction” and the other being called hereinafter “the discharging direction”; and
f) support means for supporting said container in a slightly slanted position wherein at the discharge end of said container said shaft is slightly higher than at the opposite end, hereinafter “the drive end”, of said container.

The end of said shaft near the discharge end of said container will be called “the front end”, and the end of said shaft near the drive end of said container will be called “the rear end”.

Said support means may be of any convenient kind, e.g. they may constitute a separate support structure, or a support surface, or the may be a structural part of the container, such as depending legs or plates. The angle by which the container is slanted is preferably comprised between 1 and 15 degrees.

Preferably, said appliance further comprises a conical cup at the drive end of the paddle, for drawing the residual cooking liquid through a conveniently shaped bore into said container, after the cooking process is done, by reversing the direction of rotation of said paddle shaft, and retaining said liquid into said container until manually discharged. Also preferably, the container comprises a main portion that is cylindrical and a second portion, closer to the discharge end, hereinafter “the front portion” of the container, which second portion is frusto-conical, tapering towards the discharge or front end. Accordingly, the outer diameter of the helical paddle is smaller in correspondence to the frusto-conical portion of the container than in correspondence to the main cylindrical portion.

Heating means of any convenient kind should be provided for heating the cooking liquid and maintaining it at the required high temperature during the cooking. Said heating means may be, though they need not be, a structural component of the appliance.

The container preferably comprises an upper and a lower half, connected so that the container may be opene3d to allow the removal of the paddle and paddle shaft, with the residual cooking liquid, after the cooking is done. Said two halves are separated substantially along connecting lines that are parallel to the paddle shaft, each half being symmetric with respect to a vertical plane passing through said shaft. However, said geometric conditions are not absolute and departures from them is permissible, as long as the separation of the container into two halves is such as to allow the removal of the paddle and paddle shaft by moving the upper half from a closed position, in which it forms with the lower half a closed cooking chamber, to an open position. Said upper half can be moved from the closed to the open position by pivoting it about a pivot connection to the lower half, said pivot connection defining a pivot axis parallel to the paddle shaft. Alternatively, the upper half can be completely detached from the lower half to allow the removal of the paddle and paddle shaft, as can be done e.g. if said upper half has two or more depending, vertical pins which can be inserted into corresponding vertical seats in the lower half. Other types of connection that permit the opening of the cooking chamber can be provided by skilled persons.

As has been said, said container has a discharge end comprising an opening for discharging the cooked food articles and cover means for closing said opening during the cooking operation. Preferably, said discharge opening is provided in the lower half of the container and is closed by a cover which can be displaced, preferably pivoted, from a closing position, in which it closes said opening, to a discharge position, in which it receives the cooked food articles discharged from the container. More preferably, said cover can be detached from the container and used as a basket to transport the cooked food articles.

Preferably, the said conical container located at the drive end of the paddle is solid with the paddle shaft and this latter is hollow or at least provided with an axial bore communicating with the inside of said conical container, so that residual cooking liquid drawn into said conical container and accumulated therein may be discharged after the paddle has been removed.

In one embodiment of the invention, the container comprises a heater receptacle, e.g. located below its bottom, adapted to contain an amount of cooking liquid or other liquid, an electrical resistance, and optionally a thermometer. The heater transmits heat to the container and to the cooking liquid therein, by heat conduction. Any other heating means, however, could be provided

By means of the appliance of the invention, a novel cooking method can be implemented, which method comprises the following steps:
I. Providing a cooking appliance structured and slanted as hereinbefore described;
II. Introducing an amount of cooking liquid into said appliance, which amount is sufficient to only partially immerse the food articles which are intended to be cooked;
III. Heating the cooking liquid to a temperature sufficient to cook said food articles;
IV. Introducing the food articles to be cooked into said appliance.
V. Rotating the paddle of said appliance in such a direction as to urge the food articles towards the drive end of said appliance, concurrently tumbling the food articles alternatively to immerse them into the cooking liquid and to raise them out of said liquid; and

VI. When the cooking is done, reversing the direction of the rotation of driving said paddle, whereby to urge the food articles out of the cooking appliance into a collecting container, which is preferably a displaced portion of the container itself;
VII. Thereafter, removing said paddle and paddle shaft and discharging any residual liquid retained in or in communication with said shaft.

It is to be noted that the amount of cooking liquid that is sufficient to only partially immerse the food articles, is very small, since the mesh net for collecting the cooked food, that is generally provided in prior art appliances, is not included in the appliance of the invention.

Since the cooking appliance is slanted so that its discharge end is raised, and its front portion is frusto-conical, the cooking liquid will tend to accumulate at the drive or rear end of the appliance and will form a deeper layer at said end. It will be understood that the paddle, while urging the food articles towards the drive end of the cooking container, concurrently urges the cooking liquid in the same direction, and therefore has an effect parallel to that of the slant of the container and tends to increase the depth of the cooking liquid layer at the drive end of the container. This is beneficial, since more cooking liquid will be available where the amount of food articles is greater.

As the paddle rotation is reversed and the paddle urges the food articles out of the cooking appliance into a collecting container (preferably, the displaced cover of the discharge opening), it drives them to a zone of the container in which the depth of the cooking liquid becomes lower and gradually lifts the food articles out of the cooking liquid before they are discharged from the appliance. The discharged food articles, therefore, will entrain practically no cooking liquid.

The method according to the invention, and the use of an appliance according to the invention, for frying, permits to produce crisply fried food articles by using small amounts of oil, whereby to achieve better taste, a more healthy food, lower consumption of oil and electricity, and shorter frying time. Said method and appliance may be used not only for producing crisply fried food articles retaining a minimum quantity of fry oil, but also for steaming food articles of various types, including fish, or for popping corn with a minimum quantity of oil. If the method is used for steaming food, the liquid used is water, and water will be implicitly comprised in the expression “cooking liquid”, as used herein.

### BRIEF DESCRIPTION OF THE DRAWINGS

In the drawings:

FIG. 1 is a schematic, longitudinal cross-section of a cooking appliance according to an embodiment of the invention, not showing the motor, the drive means and the support means;

FIG. 2 is a schematic perspective view of a container, according to an embodiment of the invention, opened by pivoting the upper half, the paddle shaft but not the paddle being shown;

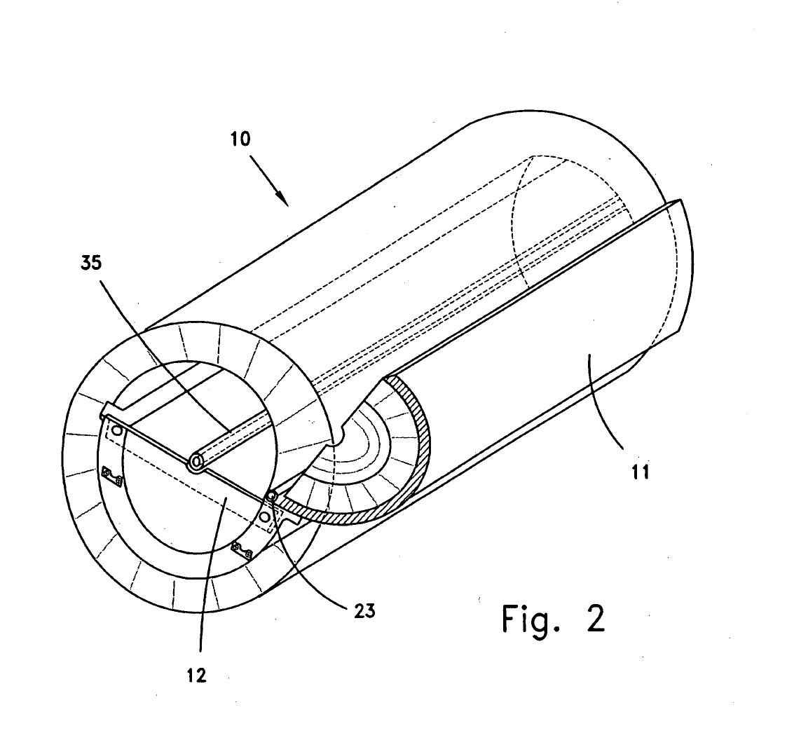

FIG. 3 is a schematic vertical view of a container, according to an embodiment of the invention, the paddle being omitted;

FIG. 4 is a schematic longitudinal cross-section of the front portion of the container, showing its front cover;

FIG. 5 schematically illustrates the swinging of the front cover from a closed to an open position;

FIG. 6 is a schematic, partial perspective view from above, of an embodiment of the container;

FIG. 7A is a schematic cross-sectional view of the paddle shaft and drive end thereof and FIG. 7B is an end view of the same;

FIG. 8 is a schematic vertical cross-section of an embodiment of a support of the paddle shaft;

FIG. 9 is a schematic view of a hopper applied to the container according to an embodiment of the invention; and

FIG. 10 is a schematic side view generally illustrating a complete appliance according to an embodiment of the invention.

### DETAILED DESCRIPTION OF PREFERRED EMBODIMENTS

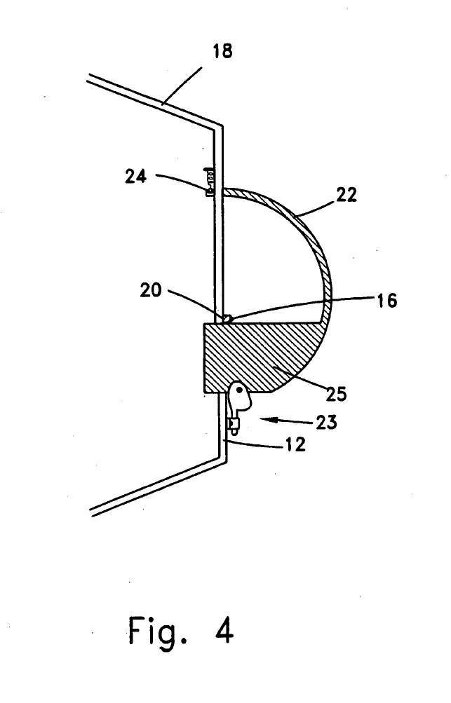

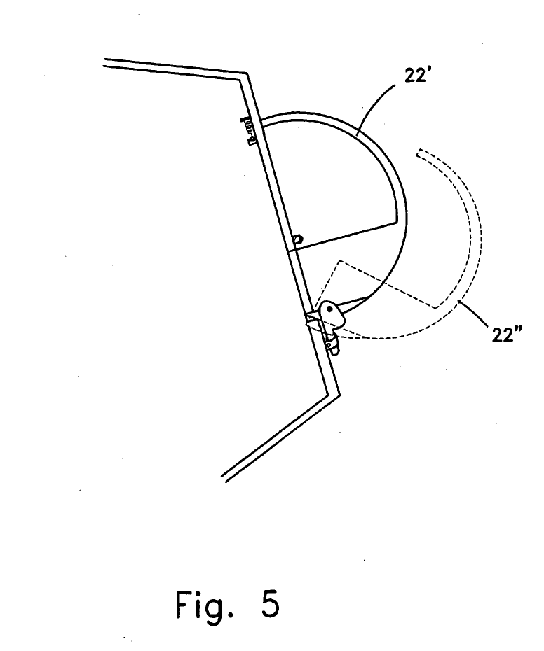

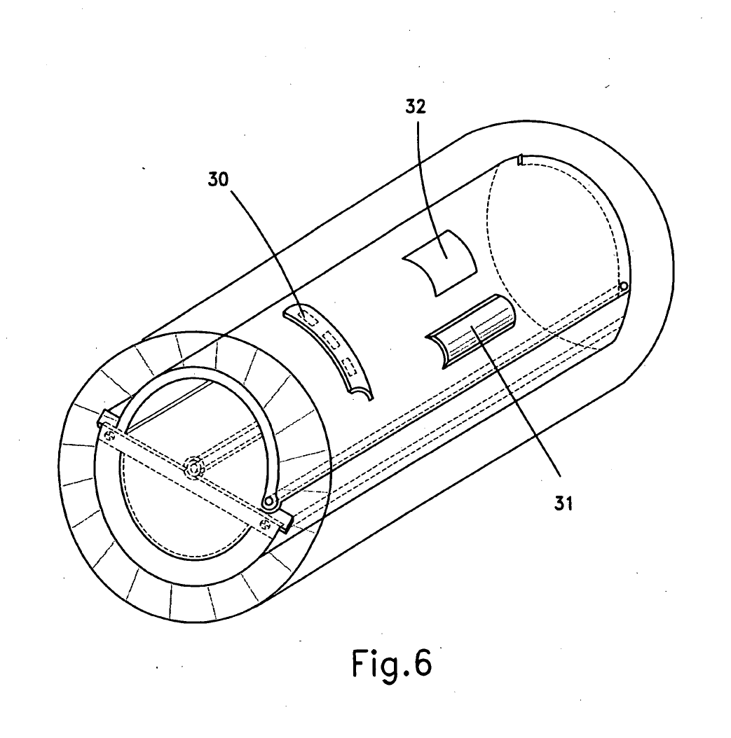

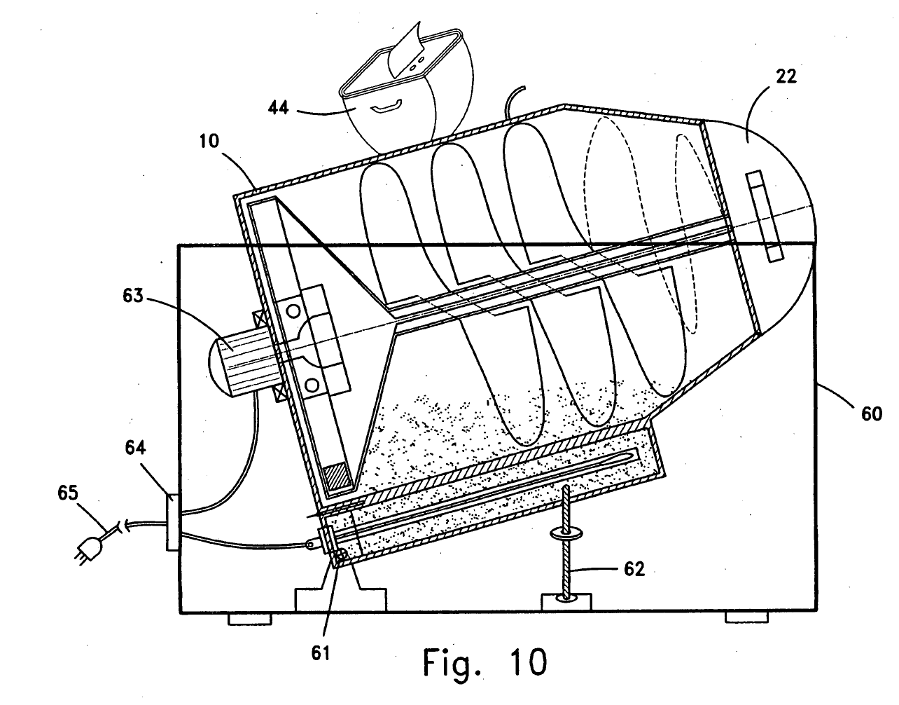

In the drawings, the cooking appliance comprises a container generally indicated at 10. As seen in FIG. 3, the container comprises an upper half 11 and a lower half 12, which are joined substantially along lines 13 and 14, parallel to and coplanar with axis 15 of hollow shaft 16. Halves 11 and 12 are symmetrical with respect to a vertical plane passing through axis 15. In longitudinal succession, container 10 comprises a cylindrical main portion 17 and a frusto-conical portion 18. Said container is closed by plate 19 at its drive end. At its discharge end, is located a transverse support bar 20 which is attached at its ends to lower container half 12 and supports shaft 16 at its front end. As seen in FIG. 4, the discharge end is closed, during the cooking, by a substantially semicircular cover 22 which is pivoted at 23 to lower half 12 of container 10 and has a snap connection, at 24, when closed, to upper container half 11. An example of snap connection is shown in FIG. 10 and comprises two balls 50 and two springs 51 housed in cavities 52 of said upper container half, but any other snap connections, among the many known to skilled persons, could be used. Cover 22 is provided at the sides of its lower portion with two side plates 25, which side over the outer surface of lower container half 12 when the cover is closed. The swinging of the cover 22 from its closed position 22′ to its open position 22″ is shown in FIG. 5. In position 22″ the cover receives the cooked food products that are discharged by the reverse rotation of paddle 26. After the discharge has occurred, cover 22 can be detached from container 10, as its joint 23 permits it, and transported where desired.

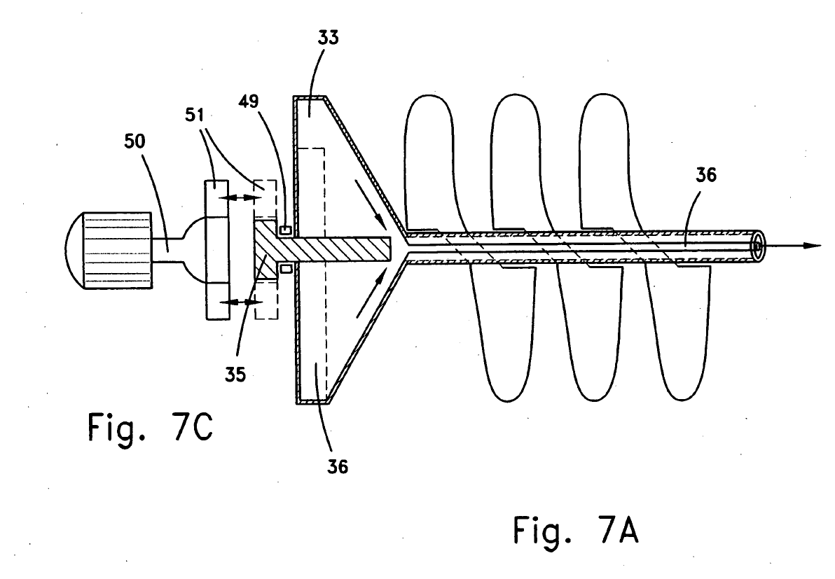

As shown in FIG. 6, container 10 is preferably provided with vent openings 30, e.g. screened with mesh wire, to discharge vapors and steam that may form in the cooking, and also, desirably, is provide with viewing opening 31, closed by a transparent closure, e.g. by glass, to permit to inspect what occurs within the container. Opening 32 permits to mount on the container 10 a hopper 44 hereinafter described.

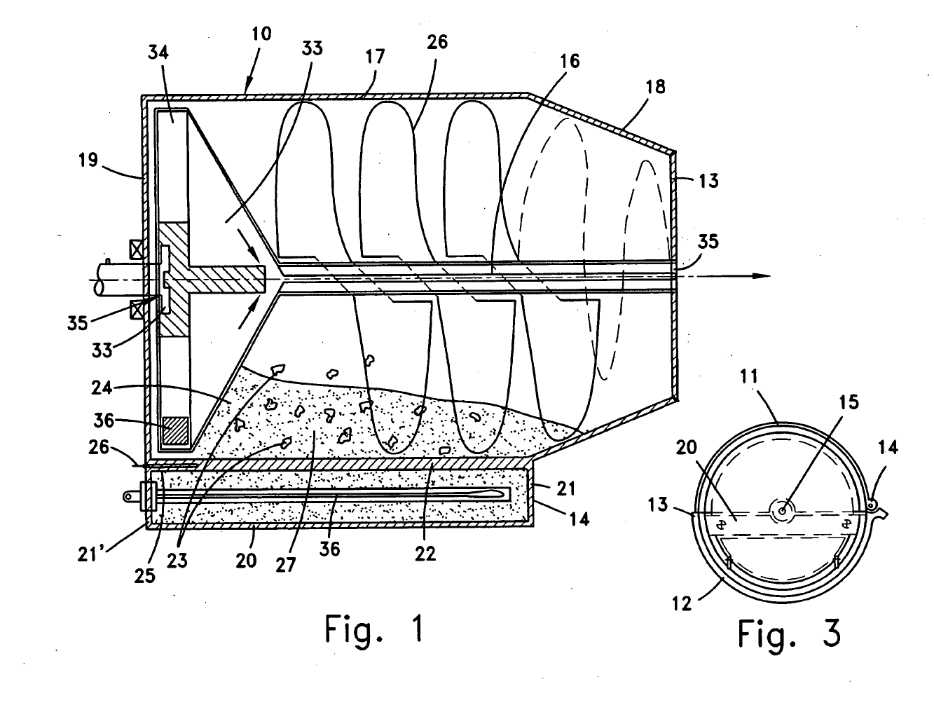

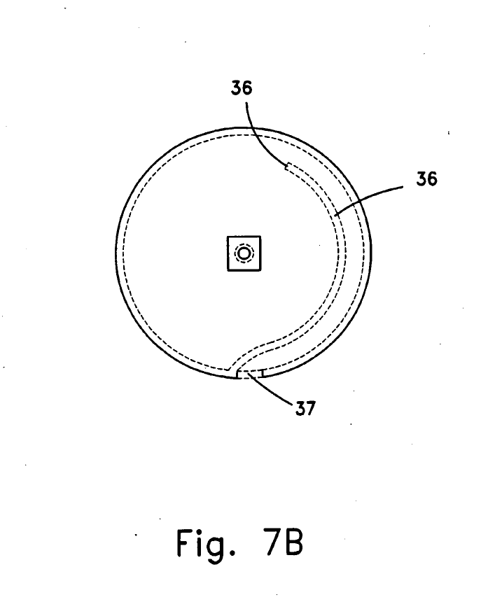

As seen in FIG. 1, the shaft 16 extends into a conical cup 33, integral or rigidly connected with it, near the drive end of container 10. The said conical cup 33 ends contains a drive connection 35, to be described hereinafter. At the base of the conical cup is formed a annular bore or conduit 36, shown in FIG. 7, which has an outer open end 37 and an inner open end 38. If shaft 16 is driven in an appropriate direction, counterclockwise as seen in FIG. 7, which occurs when the rotation of said shaft has been reversed at the end of the cooking, any cooking liquid remaining at the bottom of the container is caught by said end 38, flows through said conduit 36 and is discharged through said end 38 into conical cup 33. Once the motor has been stopped and the paddle removed, the liquid thus accumulated in cup 33 can be discharged through bore 39 of shaft 16 by manually tilting the shaft and paddle assembly.

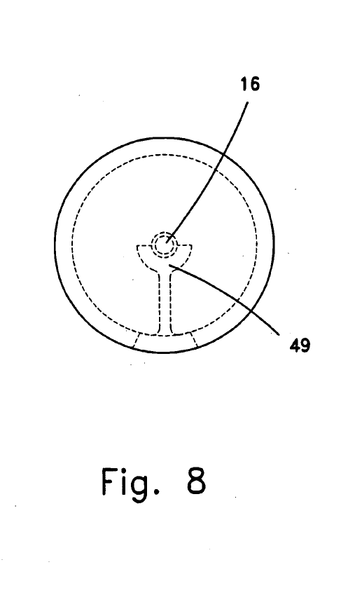

The drive shaft is supported at the drive end by a conveniently shaped, e.g. semicircular, support 49 (see FIG. 8). The drive connection 35 is illustrated in FIGS. 7A and 7B. The motor shaft 50 ends with a. conveniently shaped seat 51 for the drive end of shaft 16. In the embodiment illustrated, said seat 51 is U-shaped and the drive end of shaft 16 fits into said U-shaped seat 51. When the motor has been stopped and container 10 has been opened by removing its upper half, shaft 16 must be withdrawn from seat 51. However, to assure that such a withdrawal be carried out appropriately, it is desirable that seat 51 be in such a position that the bottom thereof be substantially horizontal, as shown in to view in FIG. 7A. Therefore a micro-switch is preferably provided, which will assure that motor shaft 50 should stop in the position in which the bottom of seat 51 is substantially horizontal.

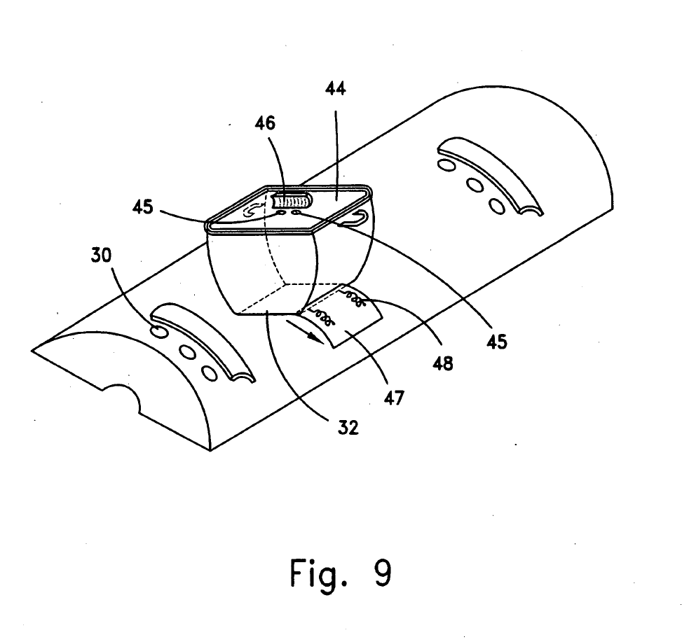

In an embodiment of the invention, illustrated in FIG. 9, a hopper 44 is located above container 10 for charging food articles into said container while avoiding contact with hot components or contents or anyway exposure to high temperatures. The hopper is provided with a vent 45 with a cover 46. The bottom 47 of the hopper can be opened to discharge the food to be loaded into the container and is normally urged to the open position by springs 48. Openings 30 as in FIG. 6 are also provided.

FIG. 10 schematically shows in lateral view a complete appliance, comprising an outer case 60 in which the container 10 is supported at a slant by a rear pivotal support 61 and a front leg 62 adjustable in height. A motor 63 is actuated through a control box 64 by a power feed connection 65. Control box 64 also controls a heater 65, such as that shown in FIG. 1, if such a heater is provided. In some embodiments, such a heater will be omitted and a heat sump, e.g. a thick piece of metal, may absorb and maintain for some time the heat developed in a cooking cycle.

The paddle end may be provided with a unidirectional element such that when the paddle turns in the direction of discharging the cooked food, it will automatically cause the cover 22 to swing to the open position, while such unidirectional element will produce no effect when the paddle turns in the cooking direction.

The cooking appliance so far described operates in the following manner. At the beginning of the operation, the motor is standing still. The container 10 is opened by lifting its upper half from its lower half. The paddle and paddle shaft are lifted from the container. The food articles to be cooked are introduced into the lower half of the container. Cooking liquid is also introduced into said lower half, in the desired amount, which will depend on the type of the intended cooking and on the type and amount of the food, and is heated to the desired cooking temperature. Both the container and the cooking liquid may be previously heated to said temperature and kept at it during the cooking. The upper half of the container is replaced, and the motor is started in the direction that will cause the food articles and the cooking liquid to be urged towards the drive end of the container. Since container 10 is slightly slanted so that its drive end is lower than its discharge end, the cooking liquid tends to accumulate near said drive end of container 10, as schematically shown in the drawings.

The motor is started to drive the shaft in such a direction that the helical paddle 26, besides tumbling the material to be cooked in and out the layer 27 of the cooking liquid, tends to displace it towards the drive end of the container. This is not harmful, because precisely at that end the layer of the cooking liquid is thicker. The rotation of the paddle alternatively lift the food articles from the cooking liquid and raises them above said liquid, as schematically shown in the drawings. In this way the desired degree of cooking is achieved. When it is achieved, the motor is stopped, container 10 is opened by removing its upper half, the front cover 22 is swung to its open position, and the rotation of the shaft 16 is reversed, whereby said shaft pushes the cooked food out of the container discharge end into said cover 22, while residual cooking liquid is drawn into conical cup 33. The upper half of the container is removed, the shaft and paddle are lifted out of the container, and the residual cooking liquid is discharged from conical cup 33 as described hereinbefore.

The above description and example have been provided for the purpose of illustration and are not intended to limit the invention in any way. The novel cooking appliance of the invention may be implemented with a variety of different mechanical solutions and for different food treatment purposes, and many modifications can be carried out in the structure of the appliance and in the steps of the method of the invention, all without exceeding the scope of the invention.

1. Appliance for cooking food articles, which comprises:
a) a container, for receiving an amount of the food articles to be cooked and an amount of cooking liquid sufficient to only partially immerse the food articles therein, said container having a discharge end comprising an opening for discharging the cooked food articles and cover means for closing said opening during the cooking operation;
b) a helical paddle;
c) a shaft on which said paddle is mounted, which shaft is rotatably supported by said container;
d) a motor for driving said shaft;
e) means for causing said motor to drive said shaft in either the cooking direction or the discharging direction; and
f) support means for supporting said container in a slightly slanted position wherein the front end of said shaft is slightly higher than the rear end thereof.

2. Appliance according to claim 1, wherein the support means are chosen from the group consisting of a separate support structure, a support surface, or a structural part of the container.

3. Appliance according to claim 1, wherein the container is slanted by an angle comprised between . . . and . . . degrees.

4. Appliance according to claim 1, further comprising a conical container at the drive end of the paddle shaft, for collecting the residual cooking liquid through a conveniently shaped bore, after the cooking process is done, by reversing the direction of rotation of said paddle shaft.

5. Appliance according to claim 1, wherein the container comprises a main cylindrical portion and a front portion which is frusto-conical, tapering towards the front end.

6. Appliance according to claim 1, further comprising heating means which may be, but need not be, a structural component of the appliance.

7. Appliance according to claim 1, wherein the container comprises an upper and a lower half, connected so that the upper part may be removed to allow the removal of the paddle with the residual cooking liquid after the cooking is done.

8. Appliance according to claim 7, wherein the two halves are separated substantially along connecting lines that are parallel to the paddle shaft, each half being symmetric with respect to a vertical plane passing through said shaft.

9. Appliance according to claim 1, further comprising an opening for discharging the cooked food articles at the discharge end thereof and cover means for closing said opening during the cooking operation.

10. Appliance according to claim 1, wherein the discharge opening is provided in the lower half of the container and is closed by a cover which can be displaced from a closing position, in which it closes said opening, to a discharge position, in which it receives the cooked food articles discharged from the container.

11. Appliance according to claim 10, wherein the cover can be displaced from a closing position to a discharge position by a pivotal displacement.

12. Appliance according to claim 10, wherein the cover can be detached from the container and used as a basket to transport the cooked food articles.

13. Appliance according to claim 4, wherein the conical container is solid with the paddle shaft and this latter is hollow and provided with an axial bore communicating with the inside of said conical container, so that residual cooking liquid received in said conical container may be discharged after the paddle has been removed.

14. Appliance according to claim 1, further comprising a heater receptacle adapted to contain an amount of liquid, an electrical resistance, and optionally a thermometer, which heater receptacle transmits heat to the container and to the cooking liquid therein, by heat conduction.

15. Appliance according to claim 1, wherein the container is provided with vent openings 30 to discharge vapors and steam that may form in the cooking.

16. Appliance according to claim 1, wherein the container is provided with a viewing opening 31, closed by a transparent closure, to permit to inspect what occurs within the container.

17. Appliance according to claim 1, further comprising a hopper located above container 10 for charging food articles into said container while avoiding contact to hot components or contents or exposure to high temperatures.

18. Appliance according to claim 5, wherein the outer diameter of the helical paddle is smaller in correspondence to the frusto-conical portion of the container than in correspondence to the main cylindrical portion.

19. Appliance according to claim 1, further comprising a motor and drive connections between the motor shaft and the paddle shaft for causing the motor to drive the paddle shaft.

20. Appliance according to claim 19, wherein the drive connections comprise a U-shaped seat at the end of the motor shaft and an end of the paddle shaft that fits into said U-shaped seat.

21. Appliance according to claim 19, further comprising a microswitch to assure that the motor shaft should stop in the position in which the bottom of the U-shaped seat is substantially horizontal.

22. Cooking method can be implemented, which comprises the following steps:
I. Providing a cooking appliance as defined in claim 1;
II. Introducing an amount of cooking liquid into said appliance, which amount is sufficient to only partially immerse the food articles which are intended to be cooked;
III. Heating the cooking liquid to a temperature sufficient to cook said food articles;
IV. Introducing the food articles to be cooked into said appliance;
V. Rotating the paddle of said appliance in such a direction as to urge the food articles towards the drive end of said appliance, concurrently tumbling the food articles alternatively to immerse them into the cooking liquid and to raise them out of said liquid; and
VI. When the cooking is done, reversing the direction of the rotation of driving said paddle, whereby to urge the food articles out of the cooking appliance into a collecting container, which is preferably a displaced portion of the container itself;
VII. Thereafter, removing said paddle and paddle shaft and discharging any residual liquid retained in or in communication with said shaft.

23. Cooking method according to claim 22, for producing crisply fried food articles retaining a minimum quantity of fry oil.

24. Cooking method according to claim 22, for steaming food articles of various types, including fish.

25. Cooking method according to claim 22, for popping corn with a minimum quantity of oil.

26. Cooking method according to claim 22, wherein the cooking liquid is water.

27. (canceled)

28. (canceled)
